(19) United States
(12) Patent Application Publication
(10) Pub. No.: US 2026/0102999 A1
(43) Pub. Date: Apr. 16, 2026

(54) PRINTING DEVICE AND MAINTENANCE METHOD

(71) Applicant: Yohsuke TERADA, Kanagawa (JP)

(72) Inventor: Yohsuke TERADA, Kanagawa (JP)

(73) Assignee: Ricoh Company, Ltd., Tokyo (JP)

(21) Appl. No.: 19/354,081

(22) Filed: Oct. 9, 2025

(30) Foreign Application Priority Data
Oct. 15, 2024 (JP) 2024-179956

(51) Int. Cl. B41J 2/045; B41J 2/165; B41J 2/175; B41J 2/20; B41J 29/377

(52) U.S. Cl. CPC B41J 2/04596; B41J 2/04563; B41J 2/04573; B41J 2/04581; B41J 2/16526; B41J 2/16532; B41J 2/175; B41J 2/20; B41J 29/377

(57) ABSTRACT

A printing device includes a head configured to discharge an ink; a circulation path through which a temperature-controlled liquid circulates through an interior of the head; a liquid feeder configured to feed the temperature-controlled liquid; a temperature detector configured to detect a head temperature or a correlation temperature correlated with the head temperature; a temperature controller including circuitry configured to control the head temperature or the correlation temperature; and an environment humidity sensor configured to detect a humidity of an environment in which the printing device is disposed.

### CROSS-REFERENCE TO RELATED APPLICATIONS

The present application is based on and claims priority to Japanese Patent Application No. 2024-179956 filed on Oct. 15, 2024, the entire contents of which are hereby incorporated by reference.

### BACKGROUND

### 1. Field of the Invention

The present disclosure relates to a printing device and a maintenance method.

### 2. Description of the Related Art

Discharge performance of a head configured to discharge liquid is changed by an increase in liquid temperature in accordance with an increase in temperature due to heat generation of a heat generator, such as a pressure generator configured to discharge liquid (e.g., a piezoelectric element), a driver integrated circuit (IC) (e.g., a switching circuit), or a head drive board disposed near the head and including a power amplifier configured to generate a drive waveform to drive a piezoelectric element.

Conversely, when the environment temperature is lower than a value that is equal to or lower than a head temperature, an ink thickens and is challenging to discharge stably. In view of this, for example, Japanese Laid-open Patent Publication No. 2021-146545 discloses a technique in which a path for a temperature-controlled liquid is provided in the head, and temperature adjustment is performed by feeding the temperature-controlled liquid to a heater for heating or to a radiator or a chiller for cooling, thereby causing the temperature of the head to fall within a fixed range. Also, a technique in which a heating waveform is applied to the head instead of using a heater to increase the head temperature is already known.

### SUMMARY

A printing device of the present disclosure includes: a head configured to discharge an ink; a circulation path through which a temperature-controlled liquid circulates through an interior of the head; a liquid feeder configured to feed the temperature-controlled liquid; a temperature detector configured to detect a head temperature or a correlation temperature correlated with the head temperature; a temperature controller including circuitry configured to control the head temperature or the correlation temperature; and an environment humidity sensor configured to detect a humidity of an environment in which the printing device is disposed. After start of the printing device, the temperature detector detects the head temperature or the correlation temperature. In response to the head temperature or the correlation temperature being lower than a threshold temperature, the temperature controller applies a heating waveform to the head to perform control to increase the head temperature or the correlation temperature to the threshold temperature, and subsequently the printing device performs a maintenance operation. The printing device changes a type of the maintenance operation performed after the application of the heating waveform in accordance with the humidity of the environment in which the printing device is disposed.

### BRIEF DESCRIPTION OF THE DRAWINGS

FIG. 1 is an explanatory schematic diagram of a printing device according to an embodiment of the present disclosure.

FIG. 2 is an explanatory plan diagram of a head unit forming a discharge unit of the printing device according to the embodiment of the present disclosure, as viewed from a nozzle surface side.

FIG. 3 is an explanatory cross-sectional diagram of an example of a head in a transverse direction (a direction orthogonal to a nozzle arrangement direction).

FIG. 4 is an explanatory plan diagram of a temperature-controlled liquid flow path, taken along the line A-A in FIG. 3.

FIG. 5 is an explanatory block diagram illustrating an ink supply system and a temperature-controlled liquid circulation system in the printing device according to the embodiment of the present disclosure.

FIG. 6 is an explanatory block diagram illustrating portions responsible for temperature control of an ink in the head and a maintenance operation before and after the temperature control.

FIG. 7 is an explanatory flow diagram illustrating an example of the maintenance operation performed by the printing device according to the embodiment of the present disclosure.

FIG. 8 is an explanatory flow diagram illustrating another example of the maintenance operation performed by the printing device according to the embodiment of the present disclosure.

FIG. 9A is a table illustrating an influence of a type of the maintenance operation on dischargeability of the ink.

FIG. 9B is a table illustrating an influence of a state of the printing device on dischargeability of the ink.

FIG. 10 is an explanatory schematic diagram illustrating an example of a temperature-controlled liquid circulation system for a plurality of head units.

FIG. 11 is an explanatory schematic diagram illustrating a connection relationship of heads with a temperature-controlled liquid supply manifold and a temperature-controlled liquid recovery manifold.

FIG. 12 is an explanatory diagram illustrating an example of a configuration of the head unit and a temperature-controlled liquid circulation path in the printing device according to the embodiment of the present disclosure.

FIG. 13 is an explanatory plan diagram illustrating an example of a configuration of the printing device according to the embodiment of the present disclosure.

### DETAILED DESCRIPTION OF THE PRESENT DISCLOSURE

In a low-humidity environment, moisture of an ink near the meniscus tends to evaporate, and dischargeability of the ink tends to deteriorate. The influence of an external humidity is not completely negligible, and thus, when the low humidity of an environment in which a printing device is disposed (which hereinafter may be referred to as a “printing-device-disposed environment”) accelerates thickening of the ink after application of a heating waveform, resulting in deterioration in dischargeability of the ink.

It is an object of the present disclosure to provide a printing device configured to perform a maintenance operation suitable for the humidity of the printing-device-disposed environment, and stably discharge an ink while suppressing unnecessary ink consumption.

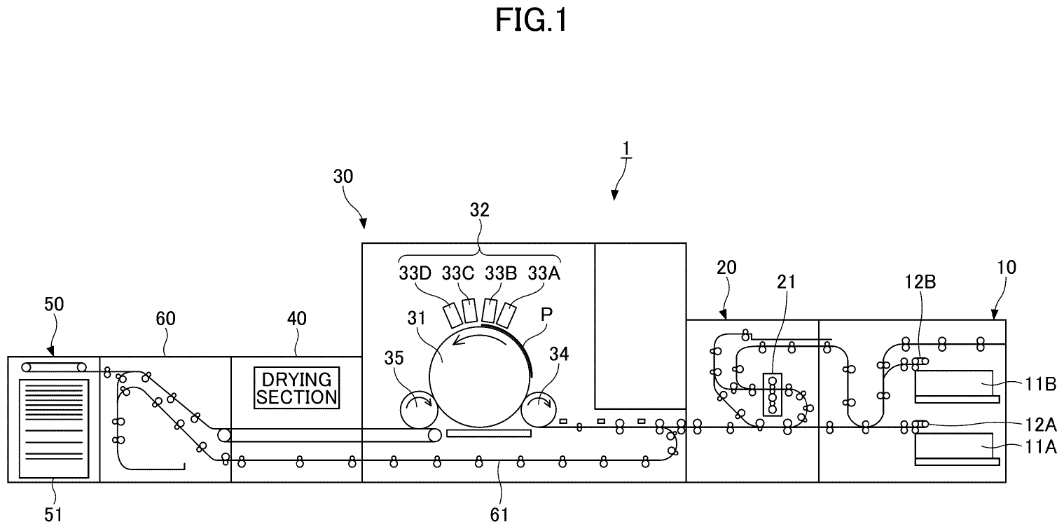

Hereinafter, embodiments of the present disclosure will be described with reference to the accompanying drawings. First, a configuration of a printing device according to the present disclosure will be described with reference to FIG. 1. FIG. 1 is an explanatory schematic diagram of a printing device according to an embodiment of the present disclosure.

A printing device 1 includes a carry-in section 10 configured to carry in a sheet material P, a pretreatment section 20, a printing section 30, a drying section 40, a carry-out section 50, and a reversing mechanism 60. The printing device 1 applies (as coating) a pretreatment liquid, if necessary, to the sheet material P, carried in (supplied) from the carry-in section 10, in the pretreatment section 20; applies an ink in the printing section 30 to perform predetermined printing; dries the ink attached to the sheet material P in the drying section 40; and ejects the sheet material P to the carry-out section 50.

The carry-in section 10 includes: carry-in trays 11 configured to house a plurality of sheet materials P (lower carry-in tray 11A and upper carry-in tray 11B); and feeders 12 (12A and 12B) configured to separate and feed the sheet materials P one by one from the carry-in trays 11. The carry-in section 10 having this configuration supplies the sheet materials P to the pretreatment section 20.

The pretreatment section 20 includes, for example, an application section 21 configured to apply a treatment liquid to a printing surface of the sheet material P. The treatment liquid has the effect of coagulating color materials of an ink to prevent bleed through.

The printing section 30 includes: a drum 31, which is a supporting member (rotating body) configured to support, and rotate, the sheet material P on the peripheral surface; and an ink discharge section 32 configured to discharge an ink toward the sheet material P supported on the drum 31.

The printing section 30 includes: a transfer cylinder 34 configured to receive the sheet material P fed from the pretreatment section 20 and transfer the sheet material P to the drum 31; and a transfer cylinder 35 configured to receive the sheet material P delivered by the drum 31 and transfer the sheet material P to the drying section 40.

The tip of the sheet material P delivered from the pretreatment section 20 to the printing section 30 is gripped by a gripper (sheet gripper) provided in the transfer cylinder 34, and the sheet material P is delivered in accordance with the rotation of the transfer cylinder 34. The sheet material P delivered by the transfer cylinder 34 is delivered to the drum 31 at a position facing the drum 31.

A gripper (sheet gripper) is also provided on the surface of the drum 31, and the tip of the sheet material P is gripped by the gripper (sheet gripper). A plurality of suction holes are formed in the surface of the drum 31 in a dispersed manner. In this state, a suction member generates a suction airflow directed inward of the desired suction holes of the drum 31.

The tip of the sheet material P delivered from the transfer cylinder 34 to the drum 31 is gripped by the sheet gripper. In this state, the sheet material P is attracted to and supported on the drum 31 by the effect of the suction airflow generated by the suction member, and delivered in accordance with the rotation of the drum 31.

The ink discharge section 32 includes discharge units 33 (33A to 33D). For example, the discharge unit 33A discharges a cyan (C) ink, the discharge unit 33B discharges a magenta (M) ink, the discharge unit 33C discharges a yellow (Y) ink, and the discharge unit 33D discharges a black (K) ink. Also, it is possible to use a discharge unit configured to discharge a special ink, such as a white ink, a gold (silver) ink, or the like.

A discharge operation of each of the discharge units 33 of the ink discharge section 32 is controlled in accordance with a drive signal corresponding to printing information. When the sheet material P supported on the drum 31 passes through a region facing the ink discharge section 32, color inks are discharged from the discharge units 33, and thus an image corresponding to the printing information is printed.

The drying section 40 is configured to dry the ink attached to the sheet material P in the printing section 30. This evaporates liquid components in the ink, such as moisture and the like. Thus, a colorant contained in the ink is fixed on the sheet material P, and curl of the sheet material P is suppressed.

The reversing mechanism 60 is configured to reverse the sheet material P in a switchback manner when performing double-sided printing on the sheet material P that passed through the drying section 40. The reversed sheet material P is delivered back to an upstream side of the transfer cylinder 34 through a delivery path 61 of the printing section 30.

The carry-out section 50 includes a carry-out tray 51 over which a plurality of the sheet materials P are stacked. The sheet materials P delivered from the drying section 40 are sequentially stacked, and retained, over the carry-out tray 51.

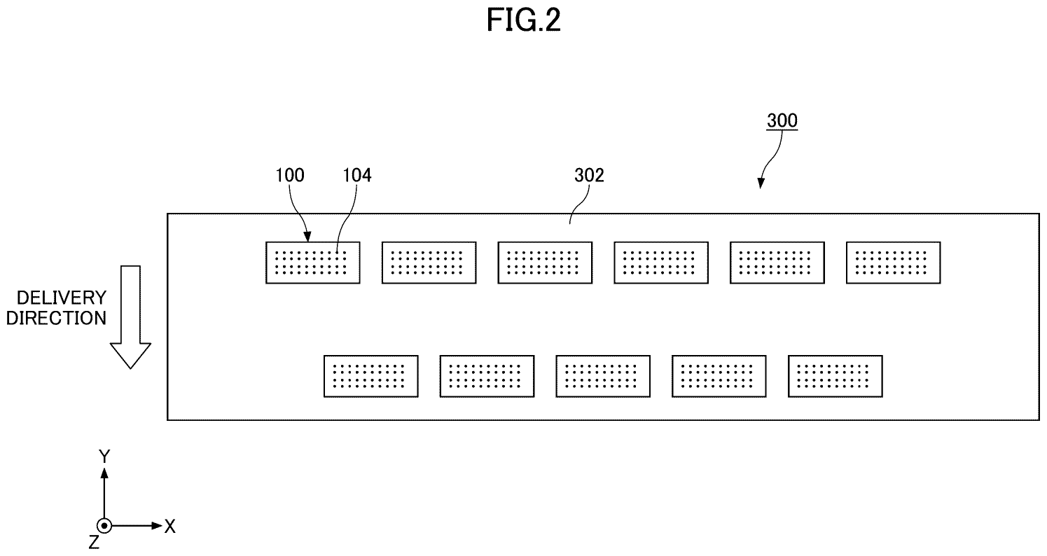

Next, an example of a head unit forming the discharge unit will be described with reference to FIG. 2. FIG. 2 is an explanatory plan diagram of the head unit forming the discharge unit of the printing device according to the embodiment of the present disclosure, as viewed from a nozzle surface side.

In a head unit 300, a plurality of heads 100 configured to discharge an ink are arranged in a staggered manner over a head mounting member 302.

Each of the heads 100 has a plurality of nozzle rows in which a plurality of nozzles 104 for discharging an ink are arranged. Note in FIG. 2 that the number of the nozzle rows is four, which is however not limiting.

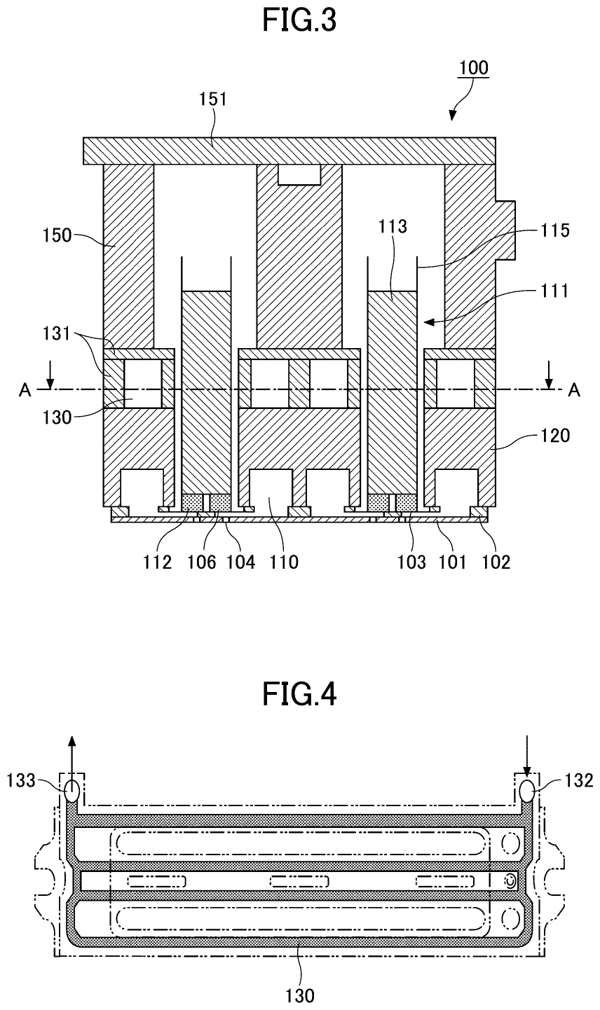

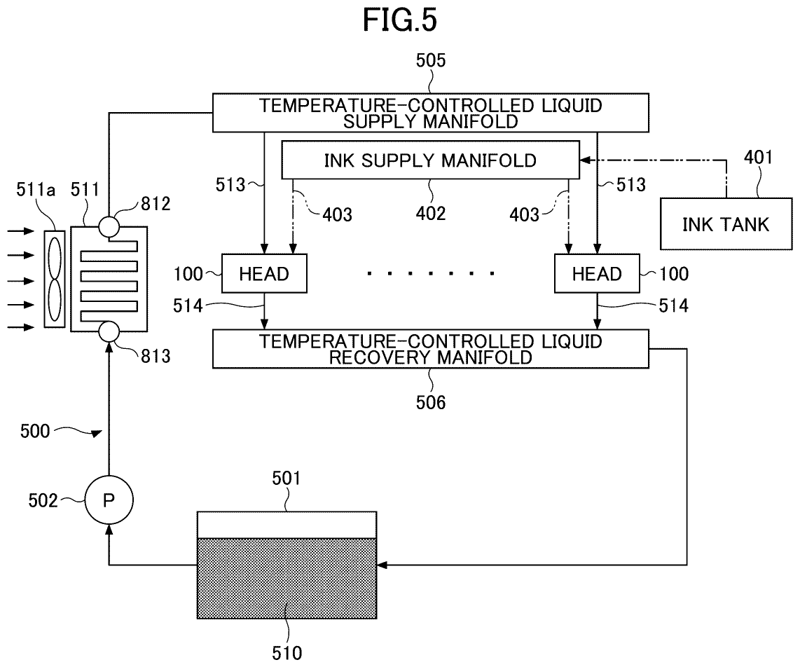

Next, an example of the head 100 will be described with reference to FIGS. 3 to 4. FIG. 3 is an explanatory cross-sectional diagram of an example of the head 100 in a transverse direction (a direction orthogonal to a nozzle arrangement direction). FIG. 4 is an explanatory plan diagram of a temperature-controlled liquid flow path, taken along the line A-A in FIG. 3.

The head 100 includes: a nozzle plate 101 in which the nozzles 104 are formed; a flow path plate 102 forming a flow path, such as, for example, a pressure chamber 106 leading to the nozzles 104; and a diaphragm 103 forming a wall surface of the pressure chamber 106. In the head 100, the nozzle plate 101, the flow path plate 102, and the diaphragm 103 are sequentially stacked. Also, the head 100 includes: a piezoelectric actuator 111 serving as a pressure generator; and a frame member 120 serving also as a common flow path member.

The piezoelectric actuator 111 includes a plurality of columnar piezoelectric elements 112 fixed on a base member 113, and the piezoelectric elements 112 are joined to the diaphragm 103. Wiring members 115, such as a flexible wiring board or the like, are connected to the piezoelectric elements 112.

The frame member 120, serving also as the common flow path member, forms a common supply flow path 110 through which an ink to be discharged into the pressure chamber 106 is supplied.

A temperature-controlled liquid flow path member 131 is joined to the frame member 120. The temperature-controlled liquid flow path member 131 is for forming a temperature-controlled liquid flow path 130 in the head 100 through which a temperature-controlled liquid (liquid whose temperature is controlled) is caused to flow. The temperature-controlled liquid flow path member 131 includes a temperature-controlled liquid supply port 132 configured to supply the temperature-controlled liquid to the temperature-controlled liquid flow path 130 and a temperature-controlled liquid recovery port 133 configured to recover the temperature-controlled liquid toward the exterior.

Thus, the common supply flow path 110, which is an ink flow path, and the temperature-controlled liquid flow path 130 are thermally bonded in the head 100. The frame member 120, serving also as a housing of the head 100, forms a wall surface of the temperature-controlled liquid flow path 130, and is thermally bonded to the temperature-controlled liquid flow path 130.

A casing member 150 and a lid member 151 are sequentially stacked over the temperature-controlled liquid flow path member 131.

Next, an ink supply system and a temperature-controlled liquid circulation system will be described with reference to FIG. 5. FIG. 5 is an explanatory block diagram illustrating an ink supply system and a temperature-controlled liquid circulation system in the printing device according to the embodiment of the present disclosure.

The printing device according to the embodiment of the present disclosure includes, as the ink supply system: an ink tank 401 configured to store an ink to be supplied to the heads 100; and an ink supply manifold 402 configured to distribute, to the heads 100, the ink supplied from the ink tank 401. The ink supply manifold 402 and each head 100 are connected through a supply path 403, such as a supply tube or the like.

The printing device according to the embodiment of the present disclosure includes, as the temperature-controlled liquid circulation system: a temperature-controlled liquid tank 501, which is a storage tank configured to store a temperature-controlled liquid 510; a liquid feeding pump 502, which is a liquid feeder configured to feed the temperature-controlled liquid 510; a radiator 511, which is a cooler configured to cool the temperature-controlled liquid 510; a temperature-controlled liquid supply manifold 505 configured to distribute the temperature-controlled liquid 510 to the heads 100; and a temperature-controlled liquid recovery manifold 506 configured to recover the temperature-controlled liquid 510 from each head 100.

The temperature-controlled liquid supply manifold 505 and the temperature-controlled liquid supply port 132 of each head 100 are connected by a supply path 513, such as a supply tube or the like. The temperature-controlled liquid recovery port 133 of each head 100 and the temperature-controlled liquid recovery manifold 506 are connected by a recovery path 514, such as a recovery tube or the like.

By driving the liquid feeding pump 502, the temperature-controlled liquid 510 stored in the temperature-controlled liquid tank 501 circulates through a circulation path 500. The circulation path 500 starts with the temperature-controlled liquid tank 501, sequentially passes through the liquid feeding pump 502, the radiator 511 serving as a cooler, the temperature-controlled liquid supply manifold 505, each head 100, and the temperature-controlled liquid recovery manifold 506, and returns to the temperature-controlled liquid tank 501.

In the system having this configuration, the temperature-controlled liquid 510 is pumped by the liquid feeding pump 502 from the temperature-controlled liquid tank 501, passes through the radiator 511, and is distributed from the temperature-controlled liquid supply manifold 505 to the heads 100.

Then, the temperature-controlled liquid 510 passes through the temperature-controlled liquid flow path 130 of each head 100 to cool the frame member 120 of each head 100 and to pass through each head 100. Subsequently, the temperature-controlled liquid 510 is recovered to the temperature-controlled liquid recovery manifold 506 and returned to the temperature-controlled liquid tank 501.

The ink is supplied from the ink tank 401 to the ink supply manifold 402, and distributed to the heads 100.

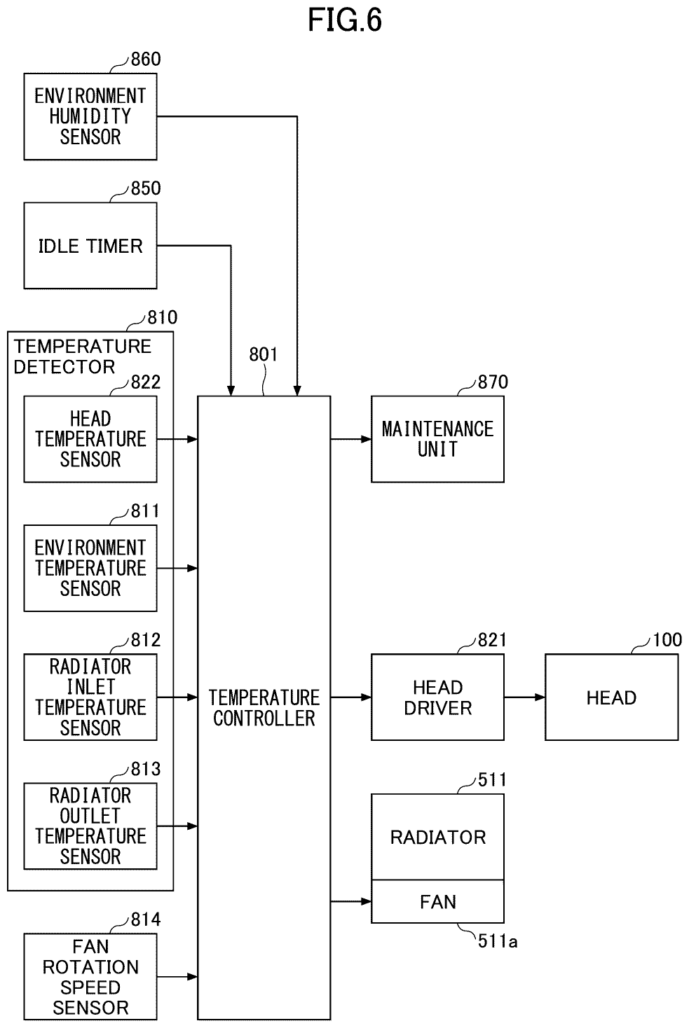

Next, temperature control of the ink in the head and a maintenance operation will be described with reference to FIG. 6. FIG. 6 is an explanatory block diagram illustrating portions responsible for the temperature control of the ink in the head and the maintenance operation before and after the temperature control.

A temperature controller 801 is configured to control a head temperature or a correlation temperature correlated with the head temperature by controlling a fan 511a of the radiator 511, a head driver 821, a maintenance unit 870, and the like based on detection results input by a sensor and the like.

Note that the temperature controller 801 is an example of the temperature controller included in the printing device according to the present disclosure. The temperature controller included in the printing device according to the present disclosure is an electronic circuit or circuitry (including a processor), such as a central processing unit (CPU), a graphics processing unit (GPU), a digital signal processor (DSP), a field programmable gate array (FPGA), an application specific integrated circuit (ASIC), or the like, and is configured to execute various processes described in the present specification by executing instruction codes stored in a memory or by being designed as a circuit or circuitry for specific applications.

A temperature detector 810 includes an environment temperature sensor 811, a radiator inlet temperature sensor 812, a radiator outlet temperature sensor 813, and a head temperature sensor 822.

The environment temperature sensor 811 is configured to detect an ambient temperature T5 of the radiator 511 and input a detection result to the temperature controller 801. The radiator 511 is disposed outside the printing device 1 for avoiding an influence of an increase in temperature inside the printing device 1. The ambient temperature (environment temperature) T5 of the radiator 511 is the same as the environment temperature of the printing device 1.

The radiator inlet temperature sensor 812 is configured to detect a temperature T1 of the temperature-controlled liquid at the inlet of the radiator 511 (hereinafter referred to as an inlet temperature) and input a detection result to the temperature controller 801. The radiator outlet temperature sensor 813 is configured to detect a temperature T2 of the temperature-controlled liquid at the outlet of the radiator 511 (hereinafter referred to as an outlet temperature) and input a detection result to the temperature controller 801.

The head temperature sensor 822 is configured to detect a temperature T3 of the head 100 and input a detection result to the temperature controller 801. Here, the ink temperature is correlated with the head temperature, and thus the head temperature sensor 822 may directly detect an ink temperature T4 in the head 100.

The inlet temperature T1 and the outlet temperature T2 are correlated with the head temperature T3. Thus, the inlet temperature T1 or the outlet temperature T2 may be input to the temperature controller 801 as the correlation temperature, and the temperature controller 801 may control the correlation temperature.

A fan rotation speed sensor 814 is configured to detect a rotation speed of the fan 511a of the radiator 511 and input a detection result to the temperature controller 801. The temperature controller 801 controls the rotation of the fan 511a of the radiator 511 based on the detection result of each sensor.

An idle timer 850 is configured to measure a period during which the printing device is left without printing, and input a measurement result to the temperature controller 801.

An environment humidity sensor 860 is configured to detect a humidity of the printing-device-disposed environment, and input a detection result to the temperature controller 801. The environment humidity sensor 860 is disposed outside the printing device 1 for avoiding an influence of change in relative humidity caused by change in temperature inside the printing device 1, and the humidity detection result is the same as the environment humidity of the printing device 1.

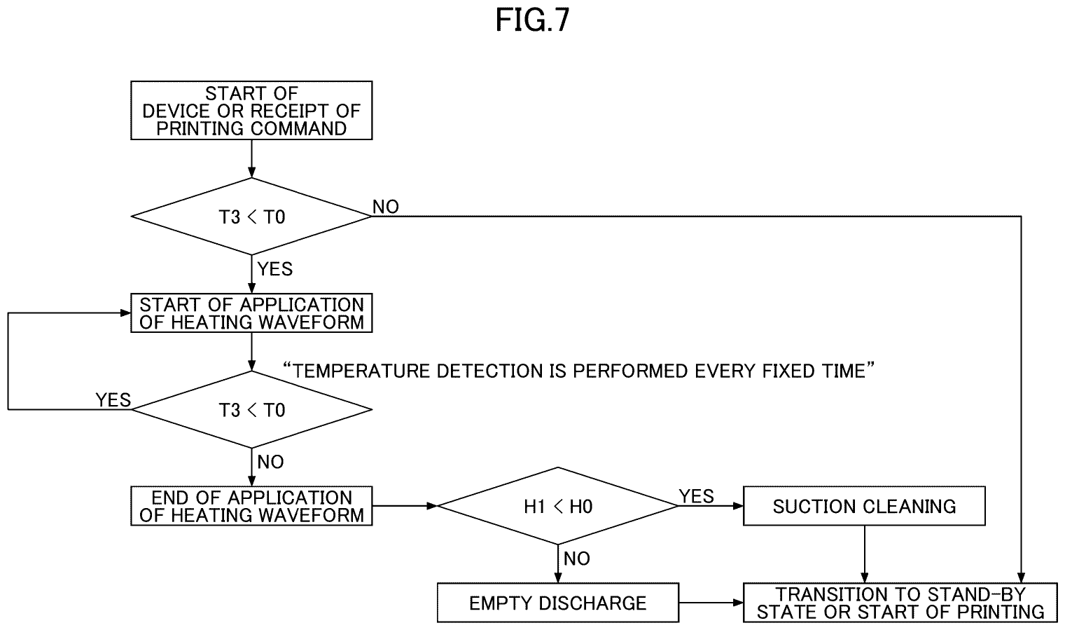

Next, head temperature control including control of the temperature-controlled liquid temperature performed by the temperature controller and head maintenance control before and after the temperature control will be described with reference to FIGS. 7 to 9.

FIG. 7 is an explanatory flow diagram illustrating an example of a maintenance operation performed by the printing device according to the embodiment of the present disclosure. After start of the printing device or after receipt of a printing command, the head temperature sensor 822 detects the head temperature T3. In response to the head temperature T3 being lower than a threshold temperature T0, the temperature controller 801 applies a heating waveform to a piezoelectric element 112 of the head 100 through the head driver 821, and performs control to drive the pressure generator of the head 100 to an extent that no ink is discharged. The heating waveform is a waveform that is deviated from a resonance point of the pressure chamber 106 of the head 100 and that drives the piezoelectric element 112 to an extent that no ink is discharged.

At the time of application of the heating waveform, the head temperature T3 and the ink temperature T4 increase (head heating mode). The head heating mode is performed in a state in which the nozzle surface of the head 100 is capped to suppress thickening of the meniscus.

Temperature detection is performed every fixed time (e.g., one second). When the head temperature T3 is equal to or higher than the threshold temperature T0, the application of the heating waveform is ended.

During the above temperature control, the influence of an external humidity is not completely negligible even in the capped state. The low environment humidity causes moisture of the ink near the meniscus to evaporate. This accelerates thickening of the ink after the application of the heating waveform, and dischargeability of the ink tends to deteriorate. In view of this, by performing a maintenance operation after the application of the heating waveform, the dischargeability of the ink can be recovered. Also, by changing a type of the maintenance operation after the application of the heating waveform in accordance with the humidity of the printing-device-disposed environment, consumption of the ink in the maintenance operation can be suppressed.

Examples of the type of the maintenance operation include: a suction cleaning operation in which a thickened ink is removed through suction; and an empty discharge operation in which a thickened ink is removed through empty discharge. The suction cleaning operation consumes a large amount of ink and requires a long period to remove the thickened ink, but has the advantage of high removal performance of the thickened ink. On the other hand, the empty discharge operation has the advantage of low ink consumption although the empty discharge operation has low removal performance of the thickened ink.

Therefore, when a humidity H1 of the printing-device-disposed environment is lower than a threshold humidity H0, the suction cleaning operation is performed, while when the humidity H1 of the printing-device-disposed environment is equal to or higher than the threshold humidity H0, the empty discharge operation is performed. This can achieve a state in which an ink can be stably discharged while suppressing unnecessary ink consumption.

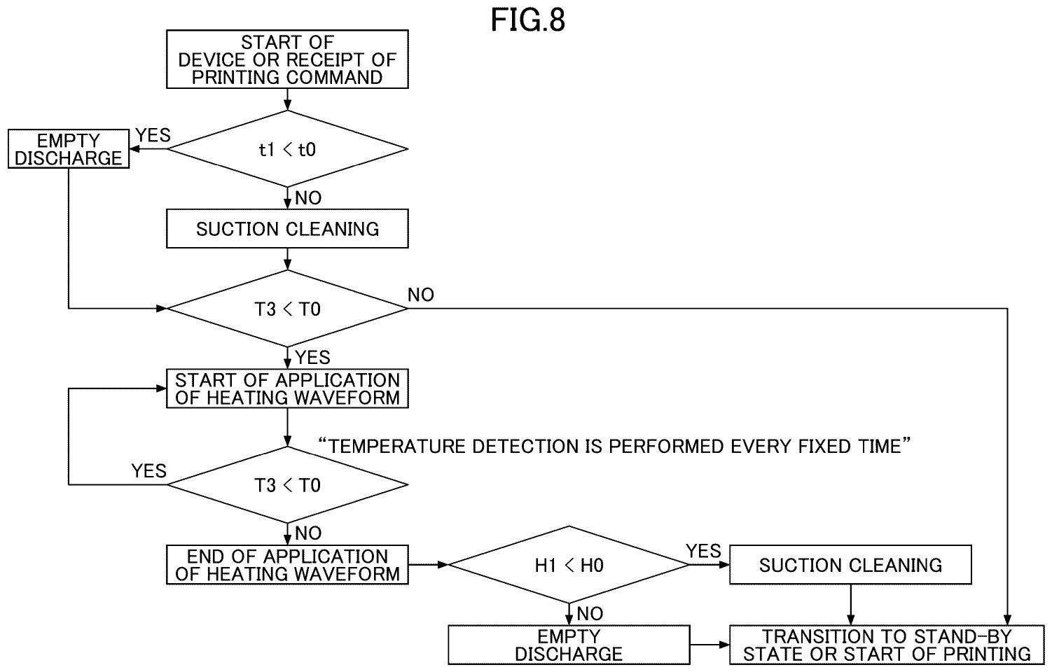

FIG. 8 is an explanatory flow diagram illustrating another example of the maintenance operation performed by the printing device according to the embodiment of the present disclosure. When the printing device is left for a long period without performing printing, thickening of an ink progresses. The application of the heating waveform in a state in which the thickened ink exists further accelerates the thickening of the ink due to sloshing of the ink. As a result, the dischargeability of the ink might not completely be recovered even if the maintenance operation is performed after the application of the heating waveform. Therefore, as illustrated in FIG. 8, by performing the maintenance operation before the application of the heating waveform to remove the thickened ink, the dischargeability of the ink can be reliably recovered by the maintenance operation after the application of the heating waveform.

The maintenance operation before the application of the heating waveform may be controlled based on a period during which the printing device is left without performing printing. For example, control may be performed such that the suction cleaning operation is performed when an idle period t1 measured by the idle timer 850 is equal to or longer than a threshold period t0, and that the empty discharge operation is performed when the idle period t1 is shorter than the threshold period t0. Also, control may be performed such that the maintenance operation is not performed when the idle period t1 is shorter than the threshold period t0.

The number of droplets of the empty discharge operation may be made variable, and the number of droplets of the empty discharge operation may be changed in accordance with the humidity H1 of the printing-device-disposed environment and the idle period t1. This can recover the dischargeability of the ink while suppressing unnecessary ink consumption in the empty discharge operation.

As illustrated in FIGS. 7 and 8, temperature detection may be performed not only at the time of start of the printing device but also at the time of receipt of a printing command. By additionally performing temperature detection immediately before printing, even if the head temperature decreases due to passage of a long period from the start of the printing device, for example, by setting of paper sheets in a state in which the environment temperature is low, the maintenance operation can be optionally performed to reliably recover the dischargeability of the ink.

Although a heating effect becomes low, a fine drive waveform used for suppressing thickening of the ink in the head not used during printing may be used as the heating waveform. In this case, it is not necessary to newly add a waveform, and consumption of a memory can be suppressed.

Regarding a temperature to be referred to, when the liquid feeding pump 502 is driven at the time of application of the heating waveform, the inlet temperature T1 or the outlet temperature T2 may be referred to in a state in which the fan 511a is stopped, and the inlet temperature T1 or the outlet temperature T2 may be detected, and controlled, as the correlation temperature.

In this case, the entire temperature-controlled liquid circulation path is heated, and thus, a heat capacity is large and a period required to increase the temperature of the head is long. However, once heated, the temperature-controlled liquid circulation path is not readily cooled, and the temperature can be stably maintained due to the large heat capacity.

When the head temperature T3 is equal to or higher than the threshold temperature T0, the liquid feeding pump 502 starts a pumping operation and the fan 511a starts an operation, thereby starting circulation and cooling of the temperature-controlled liquid 510. In this case, the head 100 is not heated by application of the heating waveform.

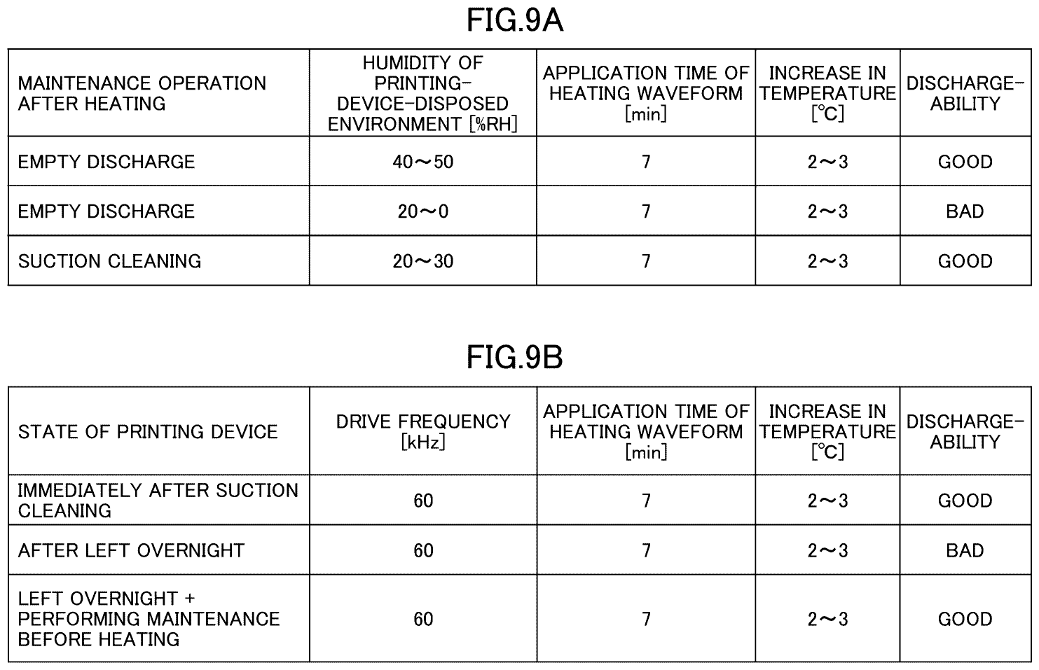

FIG. 9A is a table illustrating an influence of the type of the maintenance operation on the dischargeability of the ink. FIG. 9B is a table illustrating an influence of the state of the printing device on the dischargeability of the ink. An evaluation method of the dischargeability of the ink is as follows.

### Evaluation Method

After printing was performed for one hour at a discharge frequency of 60 kHz, the number of nozzles in which discharge abnormality (discharge failure, misdirection, and the like) occurred was confirmed. When the number of nozzles in which such discharge abnormality occurred was less than three per head, the dischargeability of the ink was evaluated to be “Good”. When the number of nozzles in which such discharge abnormality occurred was three or more per head, the dischargeability of the ink was evaluated to be “Bad”. However, when discharge failure occurred in nozzles next to each other, the dischargeability of the ink was evaluated to be “Bad” even if the number of nozzles in which such discharge abnormality occurred was less than 3 per head.

As shown in FIG. 9A, when the environment humidity is 40% RH or higher and 50% RH or lower, the dischargeability of the ink can be recovered by the empty discharge operation. When the environment humidity is 20% RH or higher and 30% RH or lower, the dischargeability of the ink is not sufficiently recovered by the empty discharge operation. Thus, by performing the suction cleaning operation instead, the dischargeability of the ink can be sufficiently recovered.

As shown in FIG. 9B, the dischargeability of the ink immediately after performing the suction cleaning operation does not have any abnormality. However, when the printing device is left overnight without printing, thickening of the ink progresses. As a result, the dischargeability of the ink decreases, and the printing quality deteriorates. Even after the printing device is left for a long period, the thickened ink can be removed by performing the maintenance operation before an increase in temperature by application of the heating waveform, and thus the dischargeability of the ink can be recovered.

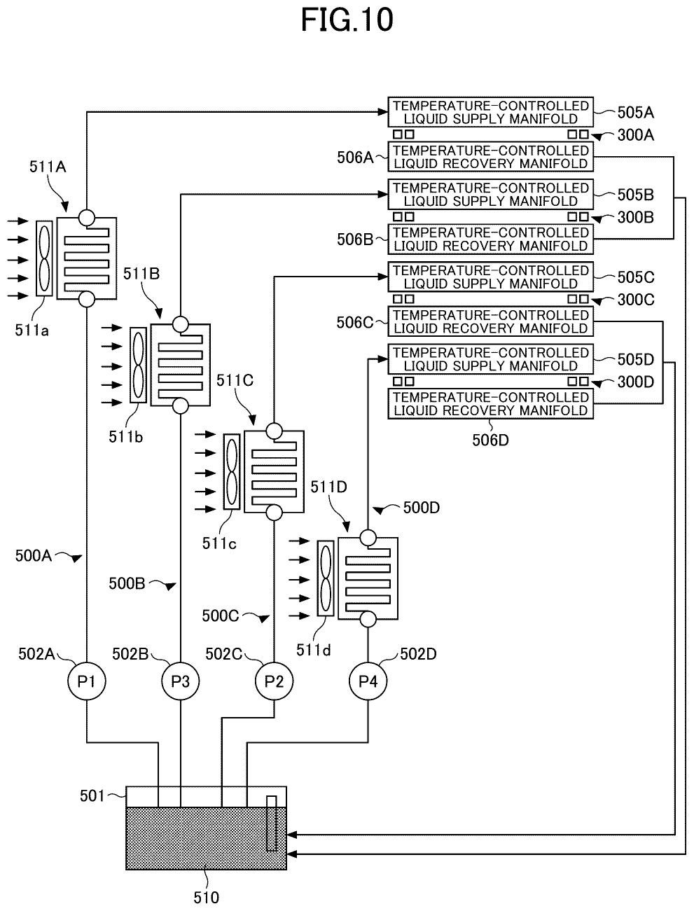

Next, an example of the temperature-controlled liquid circulation system for a plurality of head units will be described with reference to FIG. 10. FIG. 10 is an explanatory diagram referred to for the description of this example.

Here, the temperature-controlled liquid circulation system includes: temperature-controlled liquid supply manifolds 505 (505A to 505D); and temperature-controlled liquid recovery manifolds 506 (506A to 506D) corresponding to a plurality of the head units 300 (300A to 300D) including a plurality of the heads 100.

The temperature-controlled liquid circulation system includes the common temperature-controlled liquid tank 501. The temperature-controlled liquid 510 is branched and supplied from the common temperature-controlled liquid tank 501 to the temperature-controlled liquid supply manifolds 505 (505A to 505D) through the liquid feeding pumps 502 (502A to 502D) and the radiators 511 (511A to 511D).

The temperature-controlled liquid 510 that passed through the head units 300 is recovered by the temperature-controlled liquid recovery manifolds 506 (506A to 506D). Subsequently, the temperature-controlled liquid 510 is merged into two groups, i.e., the temperature-controlled liquid recovery manifolds 506A and 506B and the temperature-controlled liquid recovery manifolds 506C and 506D, and returned to the temperature-controlled liquid tank 501.

Therefore, a circulation path 500A is a path that starts with the temperature-controlled liquid tank 501, passes through the liquid feeding pump 502A, the radiator 511A, the temperature-controlled liquid supply manifold 505A, the head unit 300A, and the temperature-controlled liquid recovery manifold 506A, and returns to the temperature-controlled liquid tank 501.

Similarly, a circulation path 500B is a path that starts with the temperature-controlled liquid tank 501, passes through the liquid feeding pump 502B, the radiator 511B, the temperature-controlled liquid supply manifold 505B, the head unit 300B, and the temperature-controlled liquid recovery manifold 506B, and returns to the temperature-controlled liquid tank 501.

The circulation path 500C is a path that starts with the temperature-controlled liquid tank 501, passes through the liquid feeding pump 502C, the radiator 511C, the temperature-controlled liquid supply manifold 505C, the head unit 300C, and the temperature-controlled liquid recovery manifold 506C, and returns to the temperature-controlled liquid tank 501.

The circulation path 500D is a path that starts with the temperature-controlled liquid tank 501, passes through the liquid feeding pump 502D, the radiator 511D, the temperature-controlled liquid supply manifold 505D, the head unit 300D, and the temperature-controlled liquid recovery manifold 506D, and returns to the temperature-controlled liquid tank 501.

In this manner, the radiators 511 are connected in parallel for the head units 300.

Although the four radiators 511 are connected in parallel here, a cooler of a plurality of radiators connected in series, in parallel, or in series and in parallel may be disposed for each head unit.

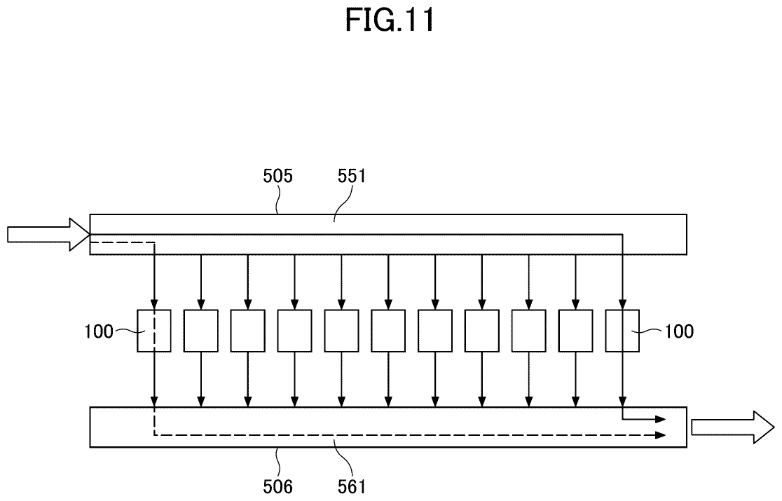

Next, a connection relationship of the heads with the temperature-controlled liquid supply manifold and the temperature-controlled liquid recovery manifold will be described with reference to FIG. 11. FIG. 11 is an explanatory schematic diagram referred to for the description of this.

The first outlet port from the most upstream side of a liquid flow path 551 of the temperature-controlled liquid supply manifold 505 is connected through the head 100 to the inlet on the most upstream side of a liquid flow path 561 of the temperature-controlled liquid recovery manifold 506. Similarly, the second outlet port from the most upstream side of the liquid flow path 551 is connected through the head 100 to the second inlet from the most upstream side of the liquid flow path 561 of the temperature-controlled liquid recovery manifold 506. Then, the outlet port on the most downstream side of the liquid flow path 551 is connected through the head 100 to the inlet on the most downstream side of the liquid flow path 561 of the temperature-controlled liquid recovery manifold 506.

With such a connection relationship, the configurations of the flow paths of the temperature-controlled liquid passing through the heads 100 are uniform. As a result, the pressure losses of the flow paths of the temperature-controlled liquid leading to the heads become equal to each other, and thus the flow rate and the flow speed become the same in the heads. Therefore, the temperatures of the heads can be adjusted to be equal to each other.

In this case, the temperature-controlled liquid recovery manifold 506 and the temperature-controlled liquid supply manifold 505 are preferably formed of the same material to have the same length.

For example, by producing the temperature-controlled liquid supply manifold 505 and the temperature-controlled liquid recovery manifold 506 through extrusion molding using an aluminum extrusion material, such as A6063 or the like, it is possible to reduce production cost.

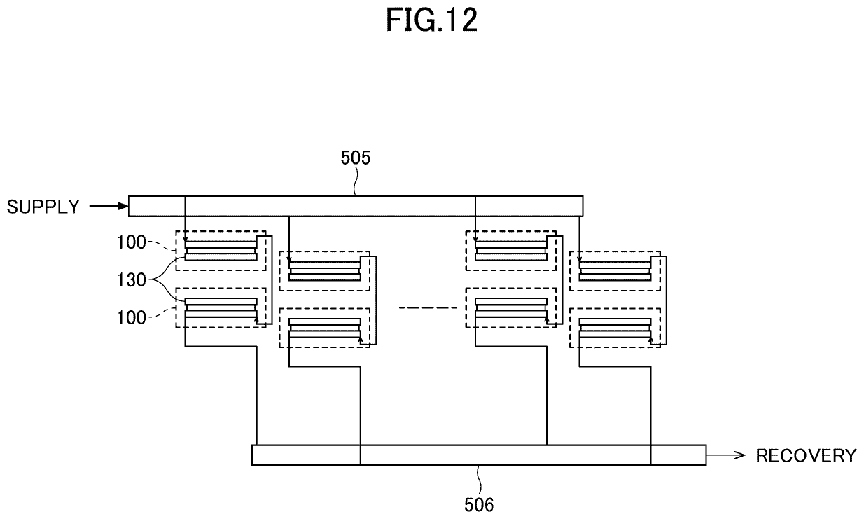

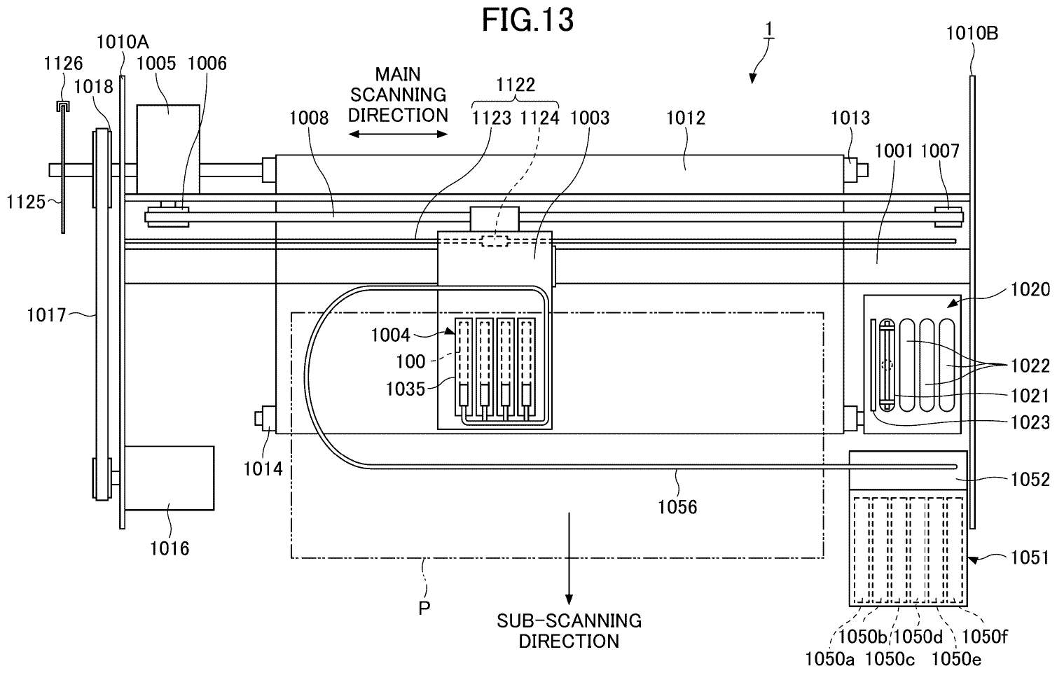

Next, the configuration of the printing device according to the embodiment of the present disclosure will be described with reference to FIGS. 12 and 13.

FIG. 12 is an explanatory diagram illustrating an example of a configuration of the head unit and the temperature-controlled liquid circulation path in the printing device according to the embodiment of the present disclosure.

The head unit 300 is formed by disposing, in a staggered manner, two groups of the heads (dual heads) 100 and 100 configured to discharge liquid.

The temperature-controlled liquid is supplied from the temperature-controlled liquid supply manifold 505 to the temperature-controlled liquid supply port 132 of one group of the heads 100 of the two groups of the heads 100 and 100, and the temperature-controlled liquid that passed through the frame member 120 of the one group of the heads 100 is recovered from the temperature-controlled liquid recovery port 133. The temperature-controlled liquid recovered from the one groups of the heads 100 is supplied to the temperature-controlled liquid supply port 132 of the other group of the heads 100, and the temperature-controlled liquid that passed through the frame member 120 of the other group of the heads 100 is recovered from the temperature-controlled liquid recovery port 133.

The temperature-controlled liquid recovered from the temperature-controlled liquid recovery port 133 of the other group of the heads 100 is recovered toward the temperature-controlled liquid recovery manifold 506.

FIG. 13 is an explanatory plan diagram illustrating an example of a configuration of the printing device according to the embodiment of the present disclosure.

The printing device 1 is a serial type printing device. A carriage 1003 is supported by a guide member to be movable back and forth in a main scanning direction. The guide member is, for example, a guide member 1001 bridging between a left side plate 1010A and a right side plate 1010B. A main scanning motor 1005 causes the carriage 1003 to move back and forth in the main scanning direction by use of a timing belt 1008 bridging between a driving pulley 1006 and a driven pulley 1007.

The carriage 1003 includes four ink discharge units 1004. The ink discharge units 1004 integrate the heads (ink discharge heads) 100 and sub-tanks 1035.

The sub-tanks 1035 include tanks configured to store color inks to be supplied to the heads 100.

A cartridge holder 1051 is disposed on a device body side. Main tanks 1050 (1050a to 1050f) storing color inks are mounted in the cartridge holder 1051 in a replaceable manner. The cartridge holder 1051 is provided with a liquid feeding pump 1052. The liquid feeding pump 1052 causes the color inks to be supplied to the sub-tanks 1035 from the main tanks 1050 through supply tubes (which may be referred to as ink supply paths) 1056 of respective colors.

The printing device 1 includes a delivery belt 1012 configured to attract the sheet material P for delivering the sheet material P, and deliver the sheet material P to a position facing the head 100. The delivery belt 1012 is an endless belt, and bridges between a delivery roller 1013 and a tension roller 1014. The delivery belt 1012 attracts the sheet material P through electrostatic attraction or air suction.

The delivery belt 1012 rotationally moves in a sub-scanning direction due to the delivery roller 1013 being rotationally driven by a sub-scanning motor 1016 through a timing belt 1017 and a timing pulley 1018.

Further, a head maintenance device 1020 is disposed on one side of the carriage 1003 in the main scanning direction and laterally to the delivery belt 1012. The head maintenance device 1020 is a maintenance and recovery mechanism configured to provide maintenance and recovery of the head 100.

The head maintenance device 1020 includes, for example, one suction cap 1021, serving also as a moisture retention cap, three moisture retention caps 1022, and a wiper 1023 configured to wipe the nozzle surface. The suction cap 1021 and the moisture retention caps 1022 are configured to cap the nozzle surface of the head 100 (the surface in which the nozzles 104 are formed).

Also, an encoder scale 1123 provided with a predetermined pattern is bridged between both the side plates along the main scanning direction of the carriage 1003, and the carriage 1003 is provided with an encoder sensor 1124 formed of a transmission type photosensor configured to read the pattern of the encoder scale 1123. The encoder scale 1123 and the encoder sensor 1124 form a linear encoder (main scanning encoder) 1122 configured to detect the movement of the carriage 1003.

A code wheel 1125 is attached to the shaft of the delivery roller 1013, and an encoder sensor 1126 formed of a transmission type photosensor configured to detect the pattern formed on the code wheel 1125 is provided. The code wheel 1125 and the encoder sensor 1126 form a rotary encoder (sub-scanning encoder) configured to detect the amount of movement and the position of movement of the delivery belt 1012.

In the device having this configuration, the sheet material P is fed and attracted onto the delivery belt 1012, and delivered in the sub-scanning direction by the rotational movement of the delivery belt 1012.

The head 100 is driven in accordance with an image signal while moving the carriage 1003 in the main scanning direction. Thus, an ink is discharged onto the stopped sheet material P to perform printing of one line. After the sheet material P is delivered a predetermined amount, printing of a subsequent row is performed.

By receiving an end signal of printing or a signal indicating that the rear end of the sheet material P has reached a region where printing is to be performed, the printing operation is ended, and the sheet material P is ejected to an ejection tray.

The present disclosure can be applied to a serial type ink discharge device according to the present embodiment.

In the present disclosure, no particular limitation is imposed on the ink to be discharged as long as the ink has a viscosity or surface tension that enables the ink to be discharged from the head. The ink preferably has a viscosity of 30 mPa·s or lower at normal temperature and under normal pressure, or through heating or cooling.

The “head” includes a head using, as an energy generating source configured to discharge an ink: a piezoelectric actuator (a multilayer piezoelectric element or a thin-film piezoelectric element); a thermal actuator using an electrothermal conversion element, such as a heat resistor or the like; an electrostatic actuator including a diaphragm and a counter electrode; or the like.

The “printing device” may include a member configured to feed, deliver, and eject an ink-attachable article, a pre-processing device, a post-processing device, and the like.

Also, the “printing device” is not limited to a device configured to allow a significant image, such as a character, a figure, or the like, to be visible by the discharged ink. For example, the “printing device” also includes a device configured to form a pattern or the like having no meaning, or a device configured to form a three-dimensional image.

The “ink-attachable article” refers to an article to which an ink can be attached at least temporarily. Specifically, the “ink-attachable article” refers to an article to which an ink is attached and adheres, an article to which an ink adheres and then permeates, or the like. Specific examples of the “ink-attachable article” include: a recording medium, such as a paper sheet, printing paper, a printing paper sheet, a film, cloth, or the like; an electronic component, such as an electronic substrate, a piezoelectric element, or the like; a medium, such as a powder layer, an organ model, an inspection cell, or the like.

A material of the “ink-attachable article” may be any material as long as an ink can be attached to the material at least temporarily. Examples of the material of the “ink-attachable article” include paper, yarn, fiber, fabric, leather, metal, plastic, glass, wood, ceramics, and the like.

Also, the “printing device” is a device in which the ink-attachable article is moved relative to the ink discharge heads. This is by no means a limitation. Specific examples of the “printing device” include a serial type device in which the ink discharge heads are moved, a line type device in which the ink discharge heads are not moved, and the like.

In addition, the “printing device” is, for example, a treatment liquid applicator configured to discharge a treatment liquid onto a sheet for applying the treatment liquid to the surface of the sheet in order to modify the surface of the sheet, or a spray granulator configured to spray a liquid composition containing raw materials dispersed in a solution through nozzles to form particles of the raw materials.

In the present disclosure, image forming, recording, printing, modeling, and the like represent the same meaning.

The embodiments of the present disclosure are, for example, as follows.

<1> A printing device, including:
a head configured to discharge an ink;
a circulation path through which a temperature-controlled liquid circulates through an interior of the head;
a liquid feeder configured to feed the temperature-controlled liquid;
a temperature detector configured to detect a head temperature or a correlation temperature correlated with the head temperature;
a temperature controller including circuitry configured to control the head temperature or the correlation temperature; and
an environment humidity sensor configured to detect a humidity of an environment in which the printing device is disposed, wherein
after start of the printing device, the temperature detector detects the head temperature or the correlation temperature,
in response to the head temperature or the correlation temperature being lower than a threshold temperature, the temperature controller applies a heating waveform to the head to perform control to increase the head temperature or the correlation temperature to the threshold temperature, and subsequently the printing device performs a maintenance operation, and
the printing device changes a type of the maintenance operation performed after the application of the heating waveform in accordance with the humidity of the environment in which the printing device is disposed.

<2> The printing device according to <1>, wherein
in response to the humidity of the environment being lower than a threshold humidity, the maintenance operation performed after the application of the heating waveform is a suction cleaning operation.

<3> The printing device according to <1> or <2>, wherein
in response to the humidity of the environment being equal to or higher than a threshold humidity, the maintenance operation performed after the application of the heating waveform is an empty discharge operation.

<4> The printing device according to any one of <1> to <3>, further including:
an idle timer configured to measure an idle period during which the printing device is left without performing printing, wherein
in response to the idle period of the printing device being equal to or longer than a threshold period, the printing device performs a suction cleaning operation as the maintenance operation before the application of the heating waveform.

<5> The printing device according to <4>, wherein
in response to the idle period of the printing device being shorter than the threshold period, the maintenance operation performed before the application of the heating waveform is an empty discharge operation.

<6> The printing device according to any one of <3> to <5>, wherein
the printing device changes a number of droplets of the empty discharge operation in accordance with the humidity of the environment in which the printing device is disposed.

<7> The printing device according to any one of <1> to <6>, wherein
the temperature controller additionally applies the heating waveform to the head immediately before start of printing to perform the control to increase the head temperature or the correlation temperature to the threshold temperature, and subsequently the printing device performs the maintenance operation.

<8> A maintenance method performed by a printing device including a head configured to discharge an ink, a circulation path through which a temperature-controlled liquid circulates through an interior of the head, a liquid feeder configured to feed the temperature-controlled liquid, a temperature detector configured to detect a head temperature or a correlation temperature correlated with the head temperature, a temperature controller including circuitry configured to control the head temperature or the correlation temperature, and an environment humidity sensor configured to detect a humidity of an environment in which the printing device is disposed, the maintenance method including:
after start of the printing device, detecting, by the temperature detector, the head temperature or the correlation temperature,
in response to the head temperature or the correlation temperature being lower than a threshold temperature, applying, by the temperature controller, a heating waveform to the head to perform control to increase the head temperature or the correlation temperature to the threshold temperature, and subsequently performing, by the printing device, a maintenance operation, and
changing, by the printing device, a type of the maintenance operation performed after the application of the heating waveform in accordance with the humidity of the environment in which the printing device is disposed.

The printing devices described in <1> to <7> and the maintenance method described in <8> can solve the above various problems and achieve the object of the present disclosure.

According to the present disclosure, it is possible to provide a printing device configured to perform a maintenance operation suitable for the humidity of the printing-device-disposed environment, and stably discharge an ink while suppressing unnecessary ink consumption.

What is claimed is:

1. A printing device, comprising:
a head configured to discharge an ink;
a circulation path through which a temperature-controlled liquid circulates through an interior of the head;
a liquid feeder configured to feed the temperature-controlled liquid;
a temperature detector configured to detect a head temperature or a correlation temperature correlated with the head temperature;
a temperature controller including circuitry configured to control the head temperature or the correlation temperature; and
an environment humidity sensor configured to detect a humidity of an environment in which the printing device is disposed, wherein after start of the printing device, the temperature detector detects the head temperature or the correlation temperature,
in response to the head temperature or the correlation temperature being lower than a threshold temperature, the temperature controller applies a heating waveform to the head to perform control to increase the head temperature or the correlation temperature to the threshold temperature, and subsequently the printing device performs a maintenance operation, and
the printing device changes a type of the maintenance operation performed after the application of the heating waveform in accordance with the humidity of the environment in which the printing device is disposed.

2. The printing device according to claim 1, wherein
in response to the humidity of the environment being lower than a threshold humidity, the maintenance operation performed after the application of the heating waveform is a suction cleaning operation.

3. The printing device according to claim 1, wherein
in response to the humidity of the environment being equal to or higher than a threshold humidity, the maintenance operation performed after the application of the heating waveform is an empty discharge operation.

4. The printing device according to claim 1, further comprising:
an idle timer configured to measure an idle period during which the printing device is left without performing printing, wherein
in response to the idle period of the printing device being equal to or longer than a threshold period, the printing device performs a suction cleaning operation as the maintenance operation before the application of the heating waveform.

5. The printing device according to claim 4, wherein
in response to the idle period of the printing device being shorter than the threshold period, the maintenance operation performed before the application of the heating waveform is an empty discharge operation.

6. The printing device according to claim 3, wherein
the printing device changes a number of droplets of the empty discharge operation in accordance with the humidity of the environment in which the printing device is disposed.

7. The printing device according to claim 1, wherein
the temperature controller additionally applies the heating waveform to the head immediately before start of printing to perform the control to increase the head temperature or the correlation temperature to the threshold temperature, and subsequently the printing device performs the maintenance operation.

8. A maintenance method performed by a printing device including a head configured to discharge an ink, a circulation path through which a temperature-controlled liquid circulates through an interior of the head, a liquid feeder configured to feed the temperature-controlled liquid, a temperature detector configured to detect a head temperature or a correlation temperature correlated with the head temperature, a temperature controller including circuitry configured to control the head temperature or the correlation temperature, and an environment humidity sensor configured to detect a humidity of an environment in which the printing device is disposed, the maintenance method comprising:
after start of the printing device, detecting, by the temperature detector, the head temperature or the correlation temperature,
in response to the head temperature or the correlation temperature being lower than a threshold temperature, applying, by the temperature controller, a heating waveform to the head to perform control to increase the head temperature or the correlation temperature to the threshold temperature, and subsequently performing, by the printing device, a maintenance operation, and
changing, by the printing device, a type of the maintenance operation performed after the application of the heating waveform in accordance with the humidity of the environment in which the printing device is disposed.
